(19) United States
(12) Patent Application Publication
(10) Pub. No.: US 2008/0063004 A1
(43) Pub. Date: Mar. 13, 2008

(54) BUFFER ALLOCATION METHOD FOR MULTI-CLASS TRAFFIC WITH DYNAMIC SPARE BUFFERING

(75) Inventors: Kevin D. Himberger, Durham, NC (US); Mohammad Peyravian, Cary, NC (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/531,473

(22) Filed: Sep. 13, 2006

(51) Int. Cl. H04L 12/26; H04L 12/56

(52) U.S. Cl. 370/413; 370/230

(57) ABSTRACT

Disclosed are a method of and system for allocating a buffer. The method comprises the steps of partitioning less than the total buffer storage capacity to a plurality of queue classes, allocating the remaining buffer storage as a spare buffer, and assigning incoming packets into said queue classes based on the packet type. When a queue becomes congested, incoming packets are tagged with the assigned queue class and these additional incoming packets are sent to said spare buffer. When the congested queue class has space available, the additional incoming packets in said spare buffer are pushed into the tail of the congested queue class.

### BACKGROUND OF THE INVENTION

1. Field of the Invention

This invention generally relates to shared memory buffer management in network nodes. More specifically, the invention relates to the use of dynamic spare buffering for multi-class network traffic.

2. Background Art

Data networks are used to transmit information between two or more endpoints connected to the network. The data is transmitted in packets, with each packet containing a header describing, among other things, the source and destination of the data packet, and a body containing the actual data. The data can represent various forms of information, such as text, graphics, audio, or video.

Data networks are generally made up of multiple network nodes connected by links. The data packets travel between endpoints by traversing the various nodes and links of the network. Thus, when a data packet enters a network node, the destination information in the header of the packet instructs the node as to the next destination for that data packet. A single data packet may traverse many network nodes prior to reaching its final destination.

Each network node may have multiple input ports and output ports. As a data packet is received at a network node, it is transmitted to its next destination in the network via an appropriate output port of the node. Depending on the amount and nature of the data packets entering a network node, it is possible that the node will not be able to output the data packets at a rate sufficient to keep up with the rate that the data packets are received. In the simplest design of a network node, newly arriving data packets may simply be discarded if the output rate of the node cannot keep up with the rate of receipt of new packets.

More advanced network nodes have a buffer stored in a memory of the network node such that data packets may be held in a queue prior to being output from the node. In such a configuration, if data packets are received at a rate faster than the node is able to output the data packets, the newly received data packets are queued in a memory buffer of the node until such time as they may be transmitted. However, since the buffer is of a finite size, it is still possible that the rate of receipt will be such that the buffer will become full. One solution is to drop any new incoming data packets when the buffer is full. However, one problem with this solution is that it may be desirable to give different types of data packets different priorities. For example, if data packets are carrying a residential telephone call, it may be acceptable to drop a data packet periodically because the degradation in service may not be noticeable by the people engaging in the conversation. However, if the data packets are carrying data for a high-speed computer application, the loss of even one data packet may corrupt the data resulting in a severe problem.

As a result of the need to differentiate the types of data packets, different data packets may be associated with different traffic classes. A traffic class is a description of the type of service the data packets are providing, and each traffic class may be associated with a different loss priority. For example, a traffic class of “residential telephone” may have a relatively low loss priority as compared with a traffic class of “high speed data”.

Buffer management due to traffic congestion is an important aspect of networking and communication systems such as routers and switches. The first line of defense against congestions is to have sufficiently large buffering available. Sufficiently large buffering is necessary to minimize packet loss and to maximize the utilization of the network links. However, switches/routers have fixed amount of memory (DRAM) and therefore their buffers have limited size. As the link capacity increases, for example from 1 Gbit/sec to 10 Gbit/sec, effective buffer management becomes even more imperative as significantly large buffers will have a major cost increase on the system. The cost impact of large buffers is even more significant when the system has to support multiple traffic classes for diversified user traffic in order to provide different classes of QoS (Quality of Service). In such systems, packets are assigned into various queue classes based on their application types. However, due to the unpredictability nature of traffic patterns, it is not feasible to accurately size each queue class. Therefore in time of congestion, some queues overflow and as a result packet loss occurs. A typical approach to minimize packet loss is to use sufficiently large queues (i.e., large memory) to minimize packet loss.

### SUMMARY OF THE INVENTION

An object of this invention is to improve buffering methods for multi-class network traffic.

Another object of the invention is to provide a dynamic spare buffering method for support of multi-class traffic, which avoids requiring large queues in the presence of unpredictable traffic patterns.

These and other objectives are attained with a method of and system for allocating a buffer. The method comprises the steps of partitioning less than the total buffer storage capacity to a plurality of queue classes, allocating the remaining buffer storage as a spare buffer, and assigning incoming packets into said queue classes based on the packet type. When a queue becomes congested, incoming packets are tagged with the assigned queue class and these additional incoming packets are sent to said spare buffer. When the congested queue class has space available, the additional incoming packets in said spare buffer are pushed into the tail of the congested queue class.

Further benefits and advantages of the invention will become apparent from a consideration of the following detailed description, given with reference to the accompanying drawings which specify and show preferred embodiments of the invention.

### BRIEF DESCRIPTION OF THE DRAWINGS

FIG. 1 is a block diagram of a network node with which the present invention may be used.

FIG. 2 is a more detailed diagram illustrating the preferred buffering method of this invention.

FIG. 3 is a flow chart showing the packet arrival operation in accordance with the preferred embodiment of this invention.

FIG. 4 is a flow chart illustrating the packet departure operation of the preferred embodiment of the present invention.

### DETAILED DESCRIPTION OF THE PREFERRED EMBODIMENTS

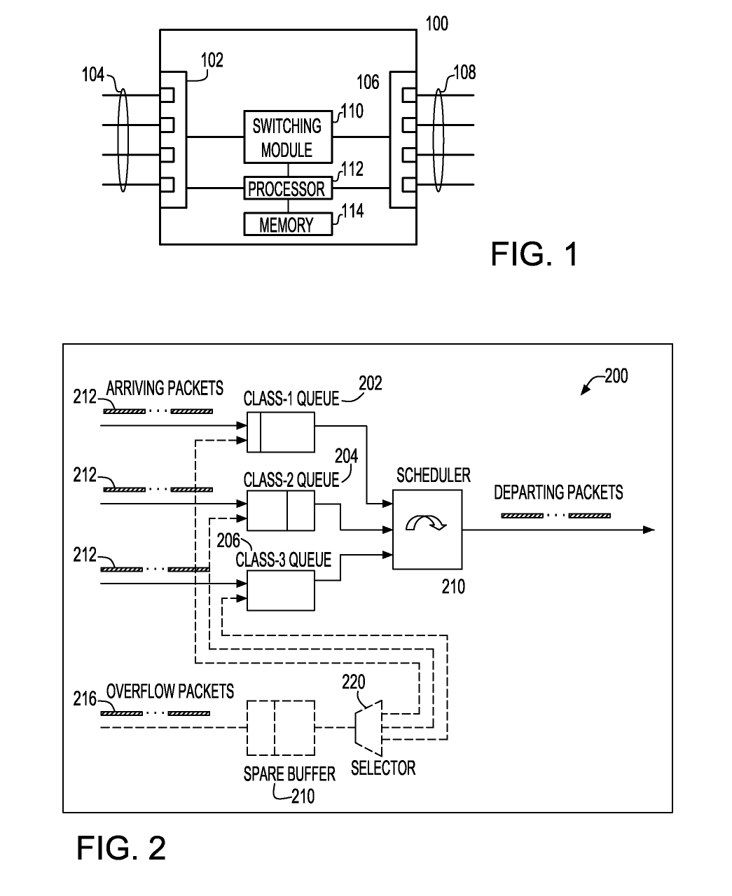

FIG. 1 shows a block diagram of a network node 100 in which the present invention may be utilized. Network node 100 includes input ports 102 for receiving data packets from input links 104. Network node 100 also includes output ports 106 for transmitting data packets on output links 108. Switching module 110 is connected to input ports 102 and output ports 106 for switching data packets received on any input link 104 to any output link 108. A processor 112 is connected to a memory unit 114, input ports 102, switching module 110, and output ports 106. The processor controls the overall functioning of the network node 100 by executing computer program instructions stored in memory 114. Although memory 114 is shown in FIG. 1 as a single element, memory 114 maybe made up of several memory units. Further, memory 114 may be made up of different types of memory, such as random access memory (RAM), read-only memory (ROM), magnetic disk storage, optical disk storage, or any other type of computer storage. One skilled in the art will recognize that FIG. 1 is a high level functional diagram of a network node configured to operate in accordance with the present invention. An actual network node would have additional elements in order to perform all the functions of a network node, however such additional elements are not shown in FIG. 1 for clarity.

In operation, as data packets are received at input ports 102 via input links 104, processor 112 will determine the appropriate output link 108 on which to output the data packet, and the processor will control switch module 110 in an appropriate manner so that the data packet is sent out on the appropriate output port 106 and output link 108. However, data packets may arrive at network node 100 at a rate, which is faster than the network node 100 can output the data packets. Therefore, at least a portion of memory 114 is configured as a buffer, so that received data packets may be stored in the buffer until ready to be output. However, it is possible that the rate of receipt of data packets will be high enough such that the buffer will fill up. In such a case, some data packets will be lost. The present invention provides a technique for managing a data packet buffer in a network node 100 for efficient use of allocated buffer memory.

FIG. 2 generally illustrates a preferred buffering method of the present invention. As in typical systems, the system memory (i.e., buffer 200) is partitioned into various queue classes for supporting different traffic types. As an example, three queue classes 202, 204, 206 are shown. In accordance with the present invention, a spare buffer 210 is also defined and is allocated some amount of memory. The system memory can be partitioned between the various queue classes and the spare buffer in different ways. For example, in one approach, the system memory can be divided up between the queues and the spare buffer in equal amount. In another approach, the system memory can be divided up between the queues based on the amount traffic expected for each traffic class with some portion set aside for the spare buffer.

The way this method with the spare buffer works is as follows. As packets 212 arrive they are assigned into various queue classes based on their type (or application type) and the queues are serviced by a scheduler 214 according to a scheduling scheme. For example, each queue can be assigned a relative weight (e.g., 35% real-time queue [class-1], 15% interactive queue [class-2], and 50% network control traffic queue [class-3]). The scheduler can then service queues in a round-robin fashion in proportion to the weights assigned to the queues.

In the normal mode of operation when no queue class is congested, the spare buffer 210 is empty. However, if a queue class gets congested, then the overflow packets, represented at 216, are tagged with their associated class and are assigned to the spare buffer. In a sense these overflow packets are linked with the tail of the congested queue. This is like increasing the size of a congested queue dynamically in real-time by the amount of the overflow packets. As packets in a congested queue class get serviced and space becomes available in the queue, the spare buffer 210 pushes the overflow packets out into the tail of the congested queue.

In the case that the spare buffer is full and overflow packets are still arriving, the arriving overflow packets are discarded.

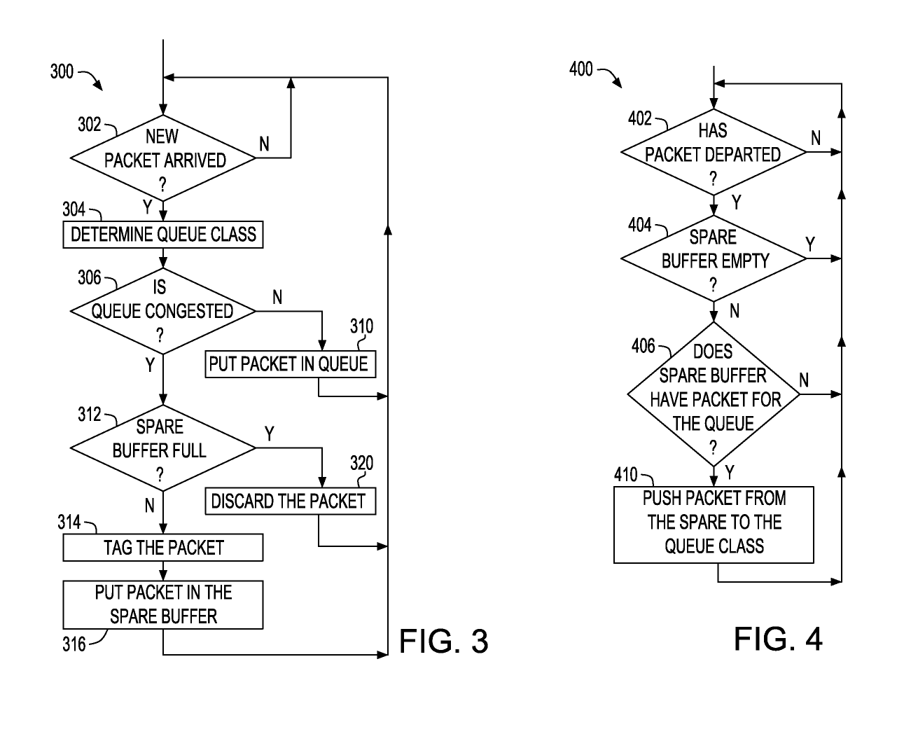

FIGS. 3 and 4 show in more detail the preferred buffer allocation procedure of the instant invention.

In particular, FIG. 3 illustrates a preferred operation, generally referenced at 300, when a data packet arrives. At step 302, a check is made to determine if a new packet has arrived. If not, the procedure loops back to repeat this step. If a packet has arrived, the procedure goes to step 304, where the routine determines the queue class in which the packet belongs. This determination can be made based on the packet type, for example, from the information coded in the packet header.

At step 306, the operation determines whether that queue class, to which the packet belongs, is congested (i.e., full). If that queue class is not congested, the packet is put in the queue class at step 310, and the routine returns to step 302. If the associated queue class is congested, the routine proceeds to step 312, where the routine determines if the spare buffer is full. If this spare buffer is not full, then at steps 314 and 316, the overflow packet is tagged with the associated queue class and put in the spare buffer, and the routine returns to step 302. However, if the spare buffer is full, the overflow packet is discarded at step 320, and the routine then returns to step 302.

FIG. 4 shows a preferred packet departure operation, generally referenced at 400. In this operation, at step 402, a check is made to determine if a packet has departed (i.e., the scheduler has serviced a packet from a queue class). If there has been no departure, the routine loops back to repeat this step. If a packet has departed, the routine moves on to step 404, where a check is made to determine if the spare buffer is empty.

If the spare buffer is empty, the routine returns to step 402. If the spare buffer is not empty, then at step 406, the routine checks to determine if the spare buffer contains a tagged packet indicating the same class as the departed packet. If there is no such packet, the routine returns to step 402. However, if there is such a tagged packet, then at step 410 that packet is pushed out from the spare buffer into the tail of the queue class from which the packet departed. (Note that the spare buffer operates in a FIFO manner for each packet class in order to preserve packet order for packets belonging to the same class. A selector logic, represented at 230 in FIG. 2, pushes the packet into the tail of the corresponding queue class.)

The packet arrival and departure operations are parallel processes, which are executed independently.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects thereof, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of allocating a buffer, comprising the steps of:
partitioning less than the total buffer storage capacity to a plurality of queue classes;
allocating the remaining buffer storage as a spare buffer;
assigning incoming packets into said queue classes based on the packet type;
when a queue becomes congested, tagging incoming packets with the assigned queue class and sending said additional incoming packets to said spare buffer; and
when the congested queue class has space available, pushing the additional incoming packets in said spare buffer into the tail of the congested queue class.

2. A method according to claim 1, wherein said buffer storage capacity is divided equally among said queue classes and spare buffer.

3. A method according to claim 1, wherein the pushing step includes the steps of:
pushing said additional packets out of the spare buffer;
selecting particular ones of said additional packets for storage in said congested queue class.

4. A method of managing a memory buffer of a network node, wherein a plurality of types of data packets are transmitted to and from the network node, said method comprising the steps of:
partitioning the memory buffer into a plurality of queue classes and a spare buffer;
as data packets of said plurality of types arrive at the network node,
assigning said data packets to said queue classes based on the types of the data packets,
storing the data packets in their assigned queue classes, until one of said queue classes becomes fall, after said one of the queues becomes fall, tagging additional data packets assigned to said of the queue classes with a tag identifying the queue class assigned to said additional data packets,
storing said additional data packets in the spare buffer;
removing the data packets from said one of the queues;
when the data packets are removed from said one of the queues,
checking the spare buffer for any data packets therein assigned to said one of the queues, and
moving at least selected ones of said any of the data packets from the spare buffer to said one of the queues.

5. A method according to claim 4, wherein the partitioning step includes the step of partitioning the entire memory buffer among said plurality of classes and said spare buffer.

6. A method according to claim 5, wherein said entire memory buffer is divided equally among said plurality of classes and said spare buffer.

7. A method according to claim 6, wherein the checking step includes the steps of:
removing the data packets from the spare buffer to identify the queue classes to which the data packets are assigned; and
returning to the spare buffer the removed data packets that are not assigned to said one of the queue class.

8. A memory buffer of a network node for storing a plurality of types of data packets transmitted to the network node, said memory buffer comprising:
a plurality of queue classes and a spare buffer;
a system controller for assigning said data packets to said queue classes based on the types of the data packets, and for storing the data packets in their assigned queue classes, until one of said queue classes becomes full; and wherein said system controller operates, after said one of the queues becomes full, for tagging additional data packets assigned to said of the queue classes with a tag identifying the queue class assigned to said additional data packets, for storing said additional data packets in the spare buffer; and
a scheduler for removing the data packets from said one of the queues;
wherein said system controller further operates, when the data packets are removed from said one of the queues, for checking the spare buffer for any data packets therein assigned to said one of the queues, and for moving at least selected ones of said any of the data packets from the spare buffer to said one of the queues.

9. A memory buffer according to claim 8, wherein the partitioning step includes the step of partitioning the entire memory buffer among said plurality of queue classes and said spare buffer have equal amounts of storage area.

10. A memory buffer according to claim 8, wherein the spare buffer operates in a FIFO manner for each packet class in order to preserve packet order for packets belonging to the same class.
